(19) United States
(12) Patent Application Publication
(10) Pub. No.: US 2009/0074645 A1
(43) Pub. Date: Mar. 19, 2009

(54) MAGNETIC NANOPARTICLES OF HYDROXYAPATITE AND PREPARATION METHOD THEREOF

(75) Inventors: HSI-CHIN WU, Taipei (TW); FENG-HUEI LIN, Taipei (TW); TZU-WEI WANG, Taipei (TW)

Correspondence Address: SCHMEISER, OLSEN & WATTS, 22 CENTURY HILL DRIVE, SUITE 302, LATHAM, NY, 12110, US

(73) Assignee: NATIONAL TAIWAN UNIVERSITY, Daan Chiu (TW)

(21) Appl. No.: 11/956,400

(22) Filed: Dec. 14, 2007

(30) Foreign Application Priority Data
Sep. 19, 2007 (TW) 096134996

(51) Int. Cl. C01B 25/12; C01F 17/00; C01B 25/00

(52) U.S. Cl. 423/263; 423/307; 423/305

(57) ABSTRACT

This invention is related to magnetic nanoparticles of hydroxyapatite for biomedical applications and the preparation method thereof. The magnetic particles of hydroxyapatite are prepared by a wet chemical co-precipitation method at lower temperature, wherein the calcium ions originally existing in hydroxyapatite are replaced with divalent or trivalent metal ions, for example, Fe+2 ion, to form magnetic nanoparticles of hydroxyapatite.

### TECHNICAL FIELD

The present invention is related to a biomedical material, particularly those containing magnetic nanoparticles of hydroxyapatite as the main component.

### BACKGROUND OF THE INVENTION

Hydroxyapatite is an inorganic substance widely used in biomedical field. As the composition of hydroxyapatite is similar to the main component of human bone and teeth, the biomedical materials produced by hydroxyapatite usually have good biocompatibility and acceptable biodegradation rate. These biomedical materials are used not only as bone graft substitute in bone surgical field, but also as carrier in drug controlled-release systems.

Recently, in order to apply hydroxyapatite in the biomedical field, it is attempted to produce hydroxyapatite in a form of magnetic nanoparticles. For example, U.S. patent application under publication No. 20070078520, published on Apr. 5, 2007, discloses a nanoparticle containing hydroxyapatite, which has magnetic property and hence can be used as an in vivo traceable agent for detection. The nanoparticle is prepared by providing a quantum dot or a magnetic nanoparticle as a nucleus; then coating the nucleus with a layer of hydroxyapatite (shell) so as to improve the applicability of the nanoparticle in the biomedical field. Although the nanoparticle containing hydroxyapatite produced by this method permit incorporation of fluorescence or magnetic property thereto, the magnetic property is not uniform through the whole nanoparticle because the outer layer and the nucleus are made of different materials. Furthermore, hydroxyapatite layer is applied to the nucleus by a coating method. The thickness of the coating layer is difficult to be controlled, which will be another factor that results in variation of the magnetic property of the nanoparticles.

Japanese Patent Application under publication No. 2000327315, published on Nov. 28, 2000, discloses a method of modifying hydroxyapatite particles with metal ions, which is characterized in modifying the surface of the hydroxyapatite particle by ion-exchange with a metal ion such that the particle is endowed with magnetic property or fluorescence. However, it is necessary to first synthesize hydroxyapatite and the subsequent modification by the ion-exchange method may result in change of composition ratio, shape or crystal size of the particle. In addition, modification is limited to the surface of hydroxyapatite; therefore, uniform magnetic property throughout the whole particle can not be obtained.

Hydroxyapatite has been widely used in the biomedical field. Due to its good biocompatibility and processiblility, lots of studies on its use as drug carriers, contrast media or heat transferring material have been conducted. It has been found that the mode of applying magnetic property to the hydroxyapatite particle, as well as the stiochiometric ratio, crystalline phase and crystal size of the hydroxyapatite particle are important factors affecting the performance of the biomedical materials containing hydroxyapatite particles.

### SUMMARY OF INVENTION

In order to resolve the problems of the prior art, namely, uneven distribution of magnetic property in hydroxyapatite particles and difficulty in controlling the thickness of outerlayer of hydroxyapatite particles, the present invention provides magnetic nanoparticles totally composed of hydroxyapatite, wherein the calcium ions originally existing in hydroxyapatite are replaced with divalent or trivalent metal ions, for example, Fe⁺², Ni⁺² or Co⁺² ion during the process of synthesis of hydroxyapatite nanoparticle by chemical co-precipitation at lower temperature, to obtain the magnetic property. As the nanoparticle according to the present invention is totally composed of hydroxyapatite and has evenly distributed magnetic property; the nanoparticle according to the present invention has better biocompatibility and magnetic property than the surface modified hydroxyapatite nanoparticle and the hydroxyapatite nanoparticle having two layers made of different materials as disclosed in the prior art.

It is another object of the present invention to provide a method for preparation of magnetic nanoparticle of hydroxyapatite, comprising, for example, mixing phosphoric acid and calcium hydroxide in a specified stoichiometric ratio in a water bath controlled at a constant temperature, adjusting the pH of the resulting mixture with ammonium water, then adding a specified amount of an aqueous solution of ferrous dichloride to form Fe⁺²-substituted hydroxyapatite nanoparticles and washing the nanoparticles with deionized water.

Through addition of a divalent metal ion such as Fe⁺² etc. or a trivalent metal ion in the process of synthesizing the hydroxyapatite nanoparticle, the hydroxyapatite nanoparticles having good paramagnetic property as well as having specified stiochiometric ratio of the components, crystalline phase and crystal size could be obtained.

The present invention also provides the use of the metal-ion-substituted hydroxyapatite nanoparticles as novel magnetic biomedical material.

According to the method of the present invention, the products produced by reaction of calcium component with phosphate component in various Ca/P ratios are collectively called “calcium phosphate”, which is endowed with magnetic property by replacing calcium ion with a divalent or trivalent metal ion other than Ca.

According to the method of the present invention, the source of calcium component is selected from, for example, calcium hydroxide (Ca(OH)₂), calcium nitrate (Ca(NO₃)₂) or calcium chloride; and the source of phosphate component is selected from, for example, phosphoric acid (H₃PO₄), dibasic ammonium phosphate ((NH₄)₂HPO₄) or sodium phosphate. The metal ion used to replace calcium ion is selected from divalent ions other than Ca or trivalent ions, for example, Fe⁺², Ni⁺², Co⁺², Al⁺³, La⁺³ or Fe⁺³. The source of iron ion is selected from, for example, iron (II) chloride (FeCl₂), iron(III) chloride (FeCl₃), Iron (III) nitrate (Fe(NO₃)₃) or iron (III) phosphate (Fe(PO₄)₃).

Said “calcium phosphate” may be hydroxyapatite (HAP) or tricalcium phosphate, wherein Ca/P ratio is preferably in a range of 0.5 to 2, most preferably 1.67. In the process of preparation of the nanoparticle, pH is controlled in the range of 1 to 14, preferably 6 to 10, most preferably 8.5; the temperature is controlled in the range of 70 to 120° C., most preferably 85° C. Phosphoric acid is added preferably at a rate of 1 to 5 mL/min, most preferably 1 mL/min. The molar ratio of the metal ion to Ca is 0 to 1.4.

### BRIEF DESCRIPTION OF DRAWINGS

FIG. 1(A) is the X-ray diffraction (XRD) spectrum for hydroxyapatite prepared by a wet chemical co-precipitation method and standard XRD spectrum for Ca₅(PO₄)₃(OH).

FIG. 1(B) is the XRD spectrum for hydroxyapatite and magnetic hydroxyapatite, wherein the Fe/Ca ratios of magnetic hydroxyapatite are 0 in (a), 0.2 in (b), 0.4 in (c), 0.6 in (d), 0.8 in (e), 1.0 in (f) and 1.4 in (g).

FIG. 2 is a graph showing the curve of the lattice constants a and c at the plane (300) and (002) calculated by Schrödinger's equation vs Fe/Ca ratio.

FIG. 3 is a graph showing the curve of crystal size vs Fe/Ca ratio for magnetic hydroxyapatite.

FIG. 4 shows the Fe/Ca ratio for magnetic hydroxyapatite as measured by inductively coupled plasma mass spectrometer.

FIG. 5 shows the functional groups in hydroxyapatite and magnetic hydroxyapatite with different Fe/Ca ratios as measured by Fourier transform infrared spectrometer, wherein the Fe/Ca ratio of magnetic hydroxyapatite is 0 in (a), 0.2 in (b), 0.4 in (c), 0.6 in (d), 0.8 in (e), 1.0 in (f) and 1.4 in (g).

FIG. 6 (A) to (D) are the photographs obtained by scanning electron microscope, showing the crystal shape of hydroxyapatite and magnetic hydroxyapatite.

FIG. 7 is the photograph of magnetic hydroxyapatite obtained by an atomic force microscope.

FIGS. 8 (A) and (B) are the Fourier transform spectrum respectively for hydroxyapatite and magnetic hydroxyapatite (Ca/Fe=0.8) obtained by high resolution transmission electron microscopy.

FIG. 9 shows the magnetic force (emu/g) of hydroxyapatite and magnetic hydroxyapatite with different Fe/Ca ratios as measured by a superconducting quantum interference device in an externally applied magnetic field of −30000 to 30000 guass, wherein the Fe/Ca ratio of magnetic hydroxyapatite is 0.2 in (a), 0.4 in (b), 0.6 in (c), 0.8 in (d), 1.0 in (e) and 1.4 in (f).

FIG. 10 shows the result of lactic acid dehydrogenase analysis after 3T3 cells have been incubated in the medium containing 0 mg/mL (control), 0.01 mg/mL, 0.05 mg/mL, 0.1 mg/mL, 0.25 mg/mL or 0.5 mg/mL of magnetic hydroxyapatite (Fe/Ca=0.8) or 1% Triton X-100.

FIG. 11 (A) is the X-ray diffraction (XRD) spectrum for m-HAP-P.

FIG. 11(B) is the X-ray diffraction (XRD) spectrum for m-HAP-M.

FIG. 11(C) is the X-ray diffraction (XRD) spectrum for m-HAP-F.

FIG. 12 (A) shows the magnetic force (emu/g) of m-HAP-P as measured by a superconducting quantum interference device.

FIG. 12 (B) shows the magnetic force (emu/g) of m-HAP-M as measured by a superconducting quantum interference device.

FIG. 12 (C) shows the magnetic force (emu/g) of M-HAP-F as measured by a superconducting quantum interference device.

### DETAILED DESCRIPTION OF PREFERRED EMBODIMENTS

The objects, features and effects of the present invention will be illustrated by the following embodiments in reference of the attached drawings

### Preparation of Hydroxyapatite

Hydroxyapatite is obtained by a co-precipitation method, wherein the following reaction is involved:

10Ca(OH)₂+6H₃PO₄→Ca₁₀(PO₄)(OH)₂+18H₂O

0.5M aqueous suspension of calcium hydroxide (Ca(OH)₂, Riedel-deHäen, USA) was prepared, then 0.3 M aqueous solution of phosphoric acid (H₃PO₄, Riedel-deHäen, USA) was added at a rate of 3 ml/min to the aqueous suspension of calcium hydroxide such that the Ca/P molar ratio was 1.67. Precipitate formed, in the meanwhile the reaction mixture was adjusted to pH of 8.5 with ammonia water (NH₄OH, Wakp Pure Chemical Industries) and stirred for 2 hours. Thereafter, the reaction mixture was allowed to stand for 20 hours. The reaction mixture was kept in a water bath of 85° C. in the whole process.

Preparation of Magnetic Hydroxyapatite (m-HAP)

Magnetic hydroxyapatite is prepared by a co-precipitation method, wherein the following reaction was involved:

10Ca(OH)₂+6H₃PO₄+XFeCl₂.4H₂→Ca₁₀₋ₓFeₓ(PO₄)₆(OH)₂+(18−4X)H₂O

To 0.5M aqueous suspension of calcium hydroxide (Ca(OH)₂, Riedel-deHäen, USA), 0.3 M aqueous solution of phosphoric acid (H₃PO₄, Riedel-deHäen, USA) was added at a rate of 3 ml/min such that the Ca/P molar ratio was 1.67. Precipitate formed, in the meanwhile the reaction mixture was adjusted to pH of 8.5 with ammonia water (NH₄OH, Wakp Pure Chemical Industries) and stirred for 2 hours. Thereafter, the reaction mixture was allowed to stand for 10 hours. An aqueous solution of ferrous dichloride with different molar concentration (0.1, 0.2, 0.3, 0.4, 0.5, 0.7M) was added at a rate of 1 mL/min to the above reaction mixture. Thereafter, the reaction mixture was adjusted back to pH of 8.5 and stirred for 2 hours. Then, the reaction mixture was allowed to stand for 10 hours. The precipitate was collected and washed by deionized water and then lyophilized to form dispersible, magnetic hydroxyapatite powder.

In addition, as described below, magnetic particle of hydroxyapatite with different magnetic property and other physical properties can be obtained by adding the iron ion source at different time.

Preparation of m-HAP-P

To 0.5M aqueous suspension of calcium hydroxide (Ca(OH)₂, Riedel-deHäen, USA), 0.3 M aqueous solution of phosphoric acid (H₃PO₄, Riedel-deHäen, USA) was added at a rate of 3 ml/min, then an aqueous solution of ferrous dichloride with different molar concentration (0.1M, 0.2M, 0.3M, 0.4M) was added at a rate of 1 mL/min. The resulting mixture was adjusted to pH of 8.5 with ammonium water and stirred for 2 hours, then was allowed to stand for 20 hours. The whole process was conducted in a water bath of 85° C. The precipitate was collected and washed with de-ionized water twice and then was lyophilized. The lyophilized precipitate was sampled for analysis.

Preparation of m-HAP-P

To 0.5M aqueous suspension of calcium hydroxide, 0.3 M aqueous solution of phosphoric acid was added at a rate of 3 ml/min. The resulting mixture was adjusted to pH of 8.5 with ammonium water and stirred for 2 hours, then was allowed to stand for 10 hours. The whole process was conducted in a water bath of 85° C. An aqueous solution of ferrous dichloride with different molar concentration (0.1M, 0.2M, 0.3M, 0.4M, 0.5M, 0.7M) was added at a rate of 1 mL/min. The resulting mixture was adjusted to pH of 8.5 with ammonium water and stirred for 2 hours, then was allowed to stand for 10 hours. The whole process was conducted in a water bath of 85° C. The precipitate was collected and washed with de-ionized water twice and then was lyophilized. The lyophilized precipitate was sampled for analysis.

Preparation of m-HAP-F

To 0.5M aqueous suspension of calcium hydroxide, 0.3 M aqueous solution of phosphoric acid was added at a rate of 3 ml/min. The resulting mixture was adjusted to pH of 8.5 with ammonium water and stirred for 2 hours, then was allowed to stand for 20 hours. The whole process was conducted in a water bath of 85° C. An aqueous solution of ferrous dichloride with different molar concentration (0.1M, 0.2M, 0.3M, 0.4M) was added at a rate of 1 mL/min. The resulting mixture was adjusted to pH of 8.5 with ammonium water and stirred for 2 hours, then was allowed to stand for 20 hours. The whole process was conducted in a water bath of 85° C. The precipitate was collected and washed with de-ionized water twice and then was lyophilized. The lyophilized precipitate was sampled for analysis.

Analysis of Hydroxyapatite (HAP) Nanoparticles and Magnetic Hydroxyapatite (m-HAP) Nanoparticles

### 1.1 X Ray Diffraction (XRD) Analysis

The crystal structures and lattice constants of the HAP and m-HAP nanoparticles were analyzed by a X-ray diffractometer (copper target; diffraction angle, 10 to 60°). The crystal size was calculated by Schrödinger's equation:

d=Kλ/B cos θ

wherein:
d is the average size of crystals
K is the shape factor
B is the width of the half-maximum of the peak on the specific plane
λ is the wavelength of X-ray
θ is the Praque diffraction angle

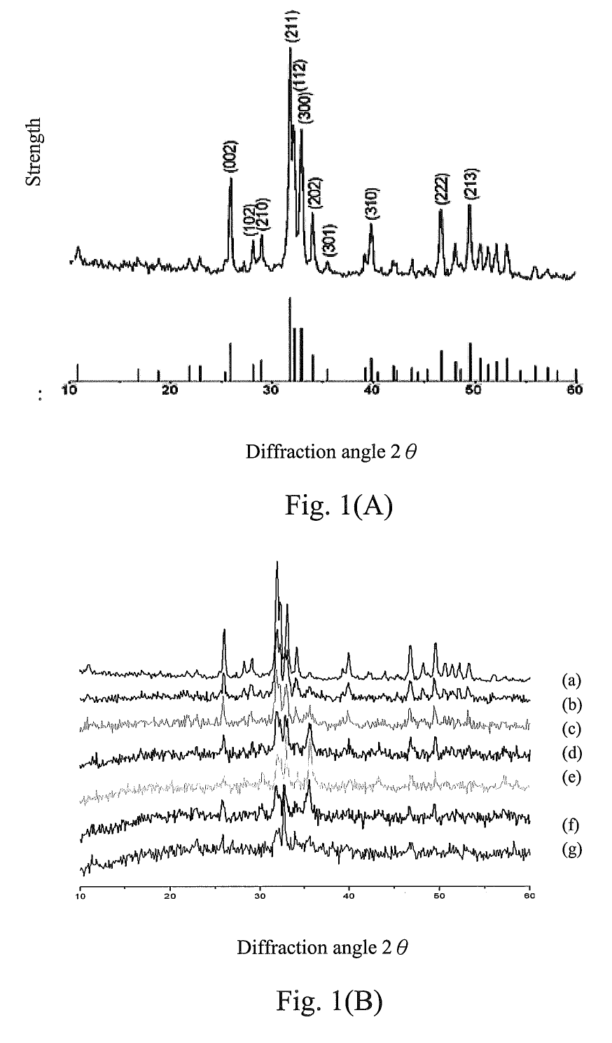

In this experiment, B is the width of the half-maximum of the peak on the plane (002). The standard XRD spectrum for hydroxyapatite (Ca₅(PO₄)₃(OH) (Joint Committee on Powder Diffraction Standards, No. 09-0432) was shown in FIG. 1(A).

### 1.2 Inductively Coupled Plasma Mass Spectrometry

The ratio of Ca/Fe in the HAP and m-HAP nanoparticles was analyzed by an inductively coupled plasma mass spectrometer. The nanoparticles were first dissolved in the mixture of nitric acid and hydrochloric acid (3:1), then digested by microwave. Measurement was performed on the product.

### 1.3 Fourier Transform Infrared Spectrometry

The functional groups in the HAP and m-HAP nanoparticles were analyzed by a Fourier transform infrared spectrometer wherein the KBr piece containing the nanoparticle was scanned for 32 times at the wavelength of 400 to 4000 m.

TABLE I

| Item | Frequency of Vibration (cm⁻¹) | | | | | | |
|---|---|---|---|---|---|---|---|
| Fe/Ca ratio | 0 | 0.2 | 0.4 | 0.6 | 0.8 | 1 | 1.4 |
| Phosphate(v2) | 476 | 471 | 463 | 474 | 480 | 480 | 459 |
| O—P—O | | | | | | | |
| Phosphate(v4) | 569 | 571 | 569 | 567 | 567 | 569 | 565 |
| O—P—O | | | | | | | |
| Phosphate(v4) | 606 | 604 | 604 | 606 | 604 | 604 | 604 |
| O—P—O | | | | | | | |
| Phosphate(v1) | 962 | 962 | 962 | 962 | 962 | 962 | 962 |
| P—O | | | | | | | |
| Phosphate(v3) | 1041 | 1039 | 1045 | 1041 | 1041 | 1041 | 1041 |
| P—O | | | | | | | |
| (unsymmetric) | | | | | | | |
| Phosphate(v3) | 1093 | 1093 | 1093 | 1095 | 1092 | 1092 | 1092 |
| P—O | | | | | | | |
| (unsymmetric) | | | | | | | |
| Hydroxide | 3546 | 3566 | 3570 | 3568 | 3568 | — | — |

### 1.5 Atomic Force Microscopy

The suspensions of the HAP and m-HAP nanoparticles were dropped on a glass slide and dried, then analyzed by an atomic force microscope.

### 1.6 High Resolution Transmission Electron Microscopy

The suspensions of the HAP and m-HAP nanoparticles were dropped on a copper grid and dried, then analyzed by high resolution transmission electron microscope.

### 1.7 Superconducting Quantum Interference Device

The magnetic property for the HAP and m-HAP nanoparticles was measured by a superconducting quantum interference device (the externally applied magnetic field is +/−30,000 gauss).

### Test For Biocompatibility In Vitro

### 2.1 Cell Incubation

Hamster ovarian fibroblast cell line 3T3 purchased from Institute of Food Science and Technology was cultured in DMEM basic medium (supplemented with 10% fetal bovine serum, 100 U/mL of penicillin and 100 μg/mL of streptomycin) at 37° C., in 5% CO₂ atmosphere. The culture of 3T3 was added at 5000 cells/well to 96-well culture plates provided with the medium containing different concentration of the nanoparticles. Thereafter, the 96-well culture plates were cultured respectively for 4 hours and 24 hours.

### 2.2 Analysis on the Lactic Acid Dehydrogenase

The cytotoxicity of the m-HAP nanoparticle was evaluated by the amount of lactic acid dehydrogenase released by the cells treated with the nanoparticles, which was measured by enzyme immunoassay using a commercially available kit at the wavelength of 490 nm. The cytotoxicity % is calculated by the following equation:

cytotoxicity %=[experimental group−high control group]/[high control group−low control group]

wherein for the high control group, the cells were cultured in the medium with addition of 1% Triton X-100 but without addition of nanoparticles; for the low control group, the cells were cultured in the medium without addition of Triton X-100 and the nanoparticles; for the experimental group, the cells were cultured in the medium with addition of the nanoparticles at different concentration.

### Results

The experimental data were analyzed by one-way analysis of variation (difference among the values evaluated at different time, p<0.05) and expressed by the average value ± standard deviations.

X-ray diffraction analysis on the crystal structures of HAP and m-HAP produced by wet chemical co-precipitation method shows that HAP has a XRD spectrum similar to the standard spectrum (Joint Committee on Powder Diffraction Standards No. 09-0432) (Figure I(A)), and m-HAP has the same XRD spectrum as HAP without formation of the second phase (See FIG. 1 (B)).

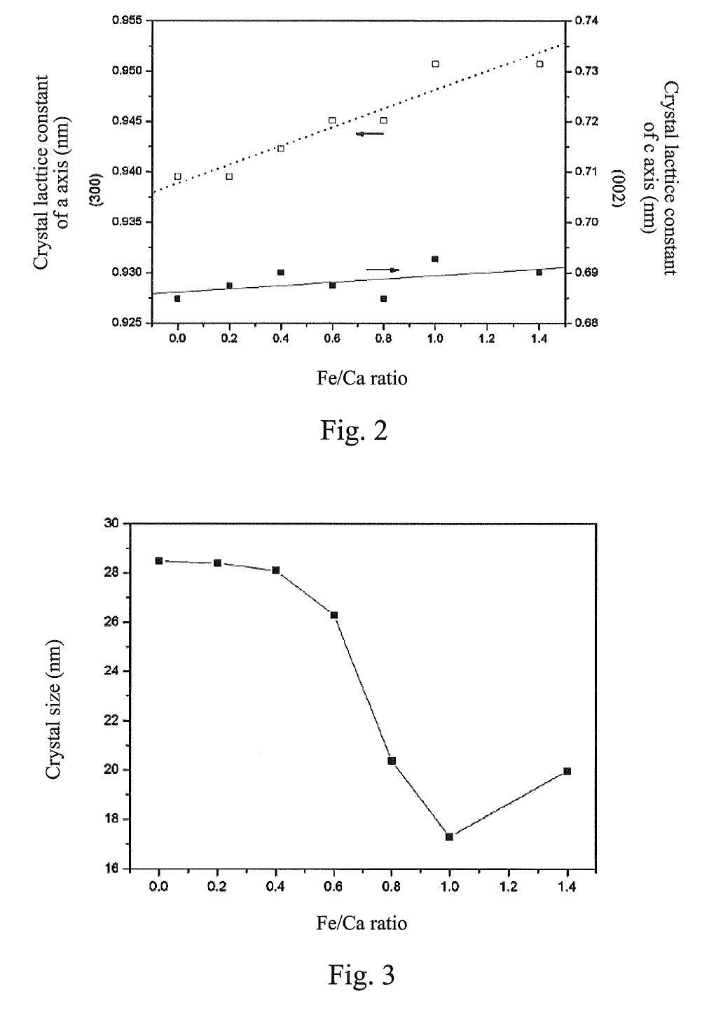

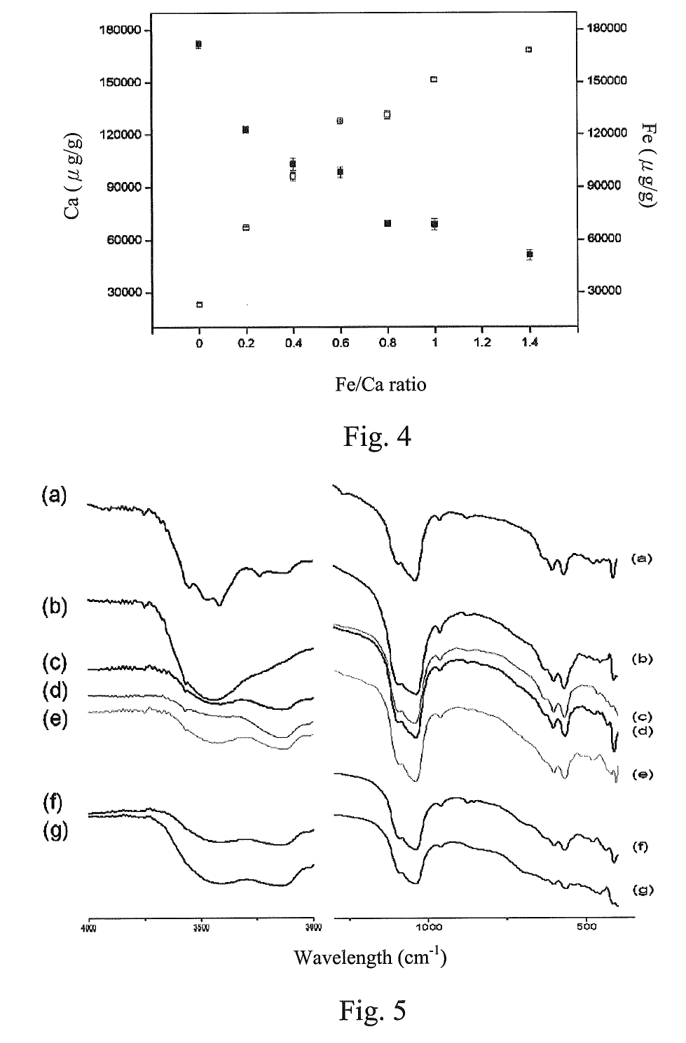

The lattice constants a and c of m-HAP as calculated by Schrödinger's equation varies slightly with the change in the amount of Fe added, but does not show significant difference when compared with those of HAP control (See FIG. 2), this indicates that incorporation of Fe into HAP will not significantly change its crystal structure. However, the crystal size varies slightly with the change in the amount of Fe added (17 to 29 nm) (See FIG. 3). The content of Ca and Fe in m-HAP measured by inductively coupled plasma mass spectrometer shows that Ca content reduces when the amount of Fe added increases (See FIG. 4), this confirms that Ca atom is replaced with Fe atom by substitution. Analysis by Fourier transform infrared spectrometry demonstrates that there is no difference between m-HAP and HAP in chemical structure and functional groups (See FIG. 5 and Table 1). The crystal and the chemical structure of HAP are not affected by incorporation of Fe, and m-HAP shows uniform single phase.

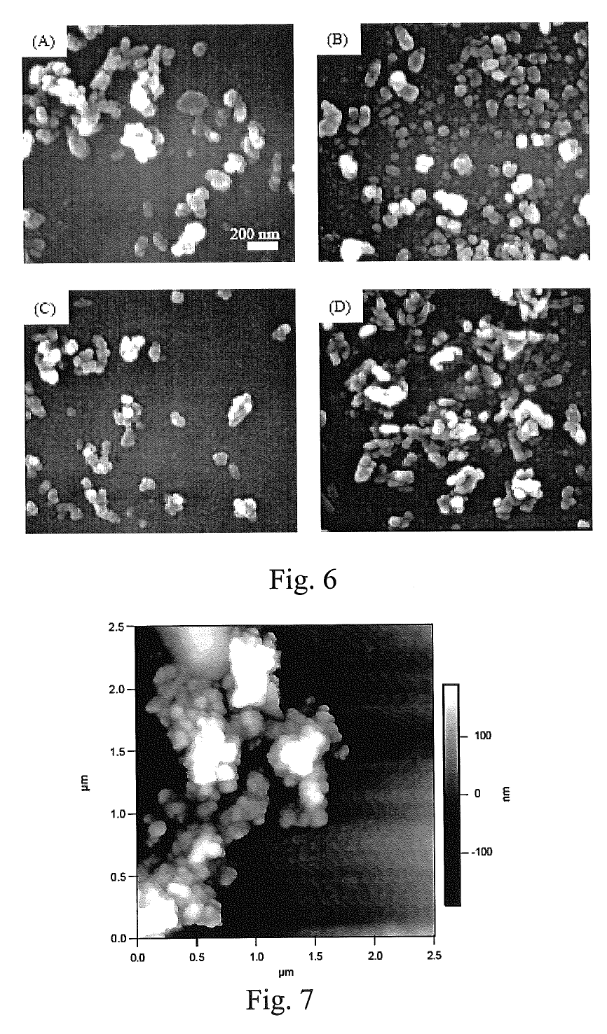

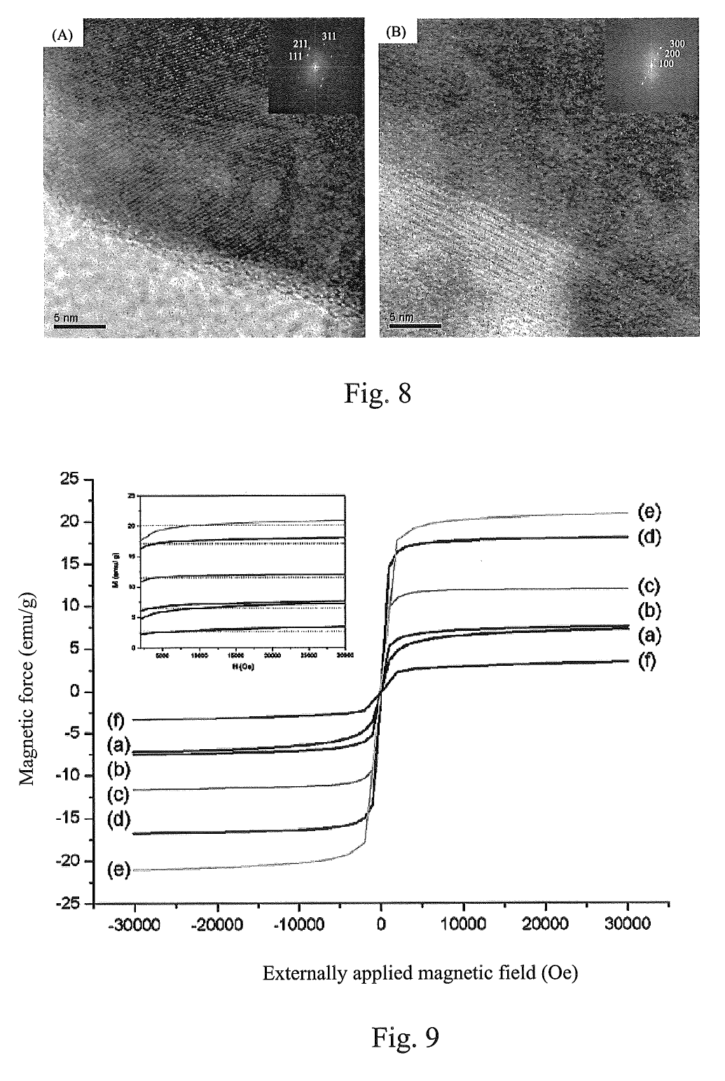

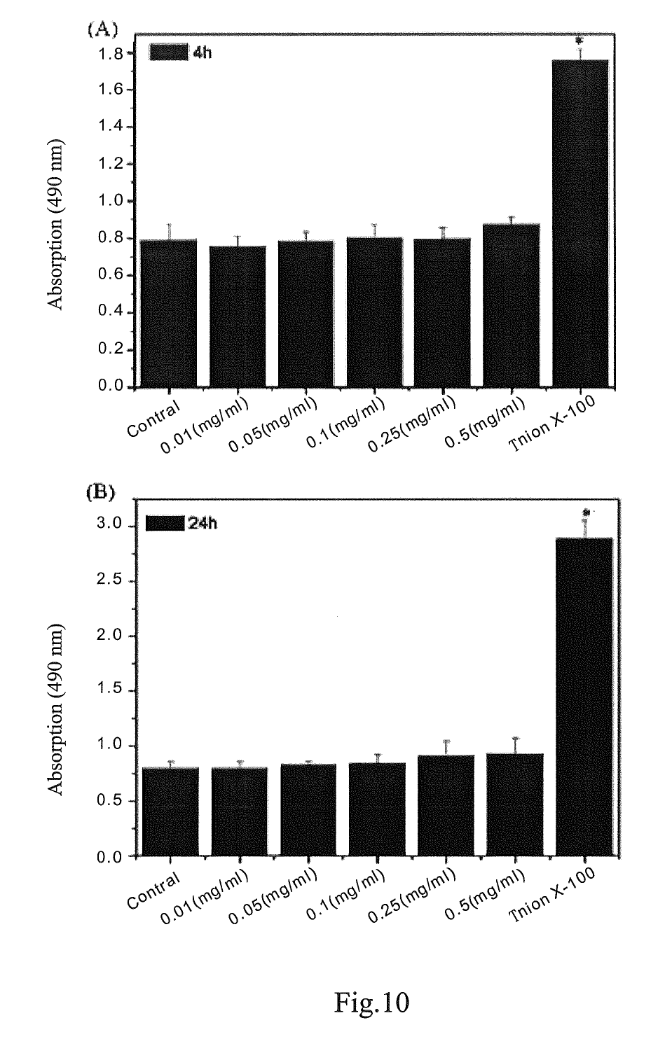

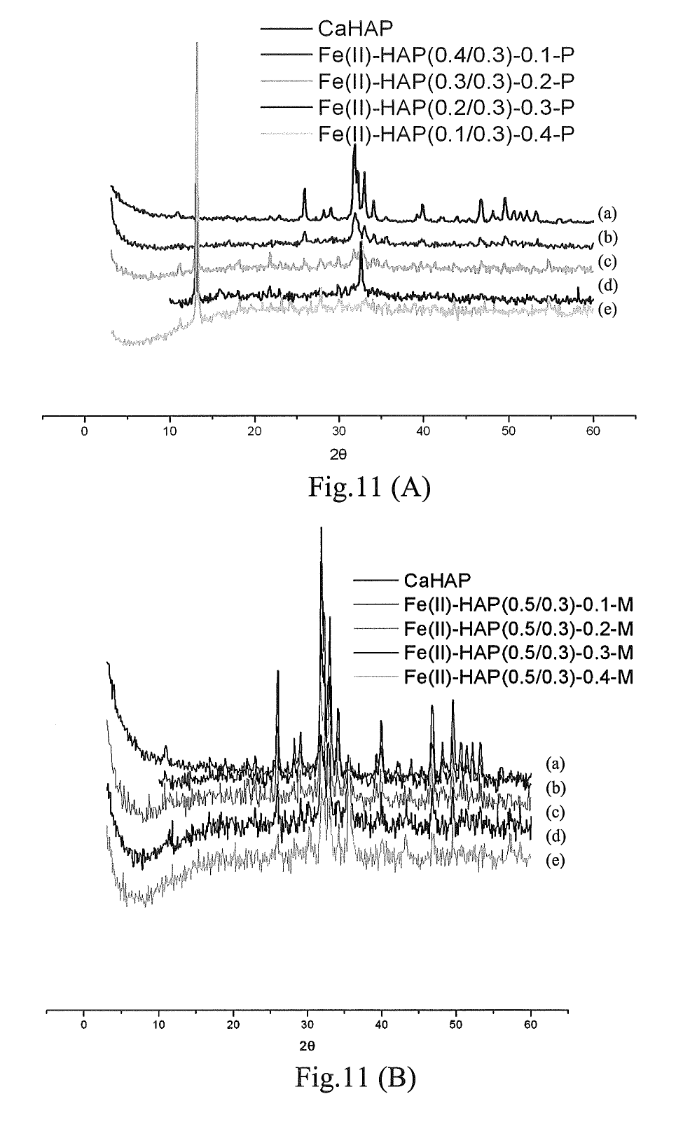

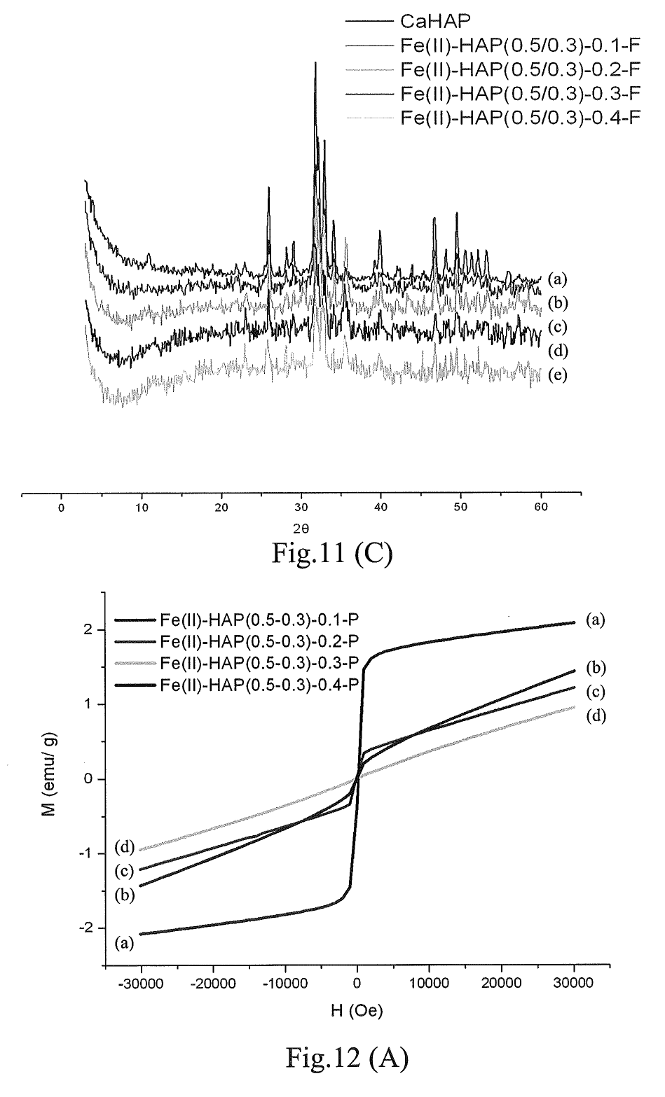

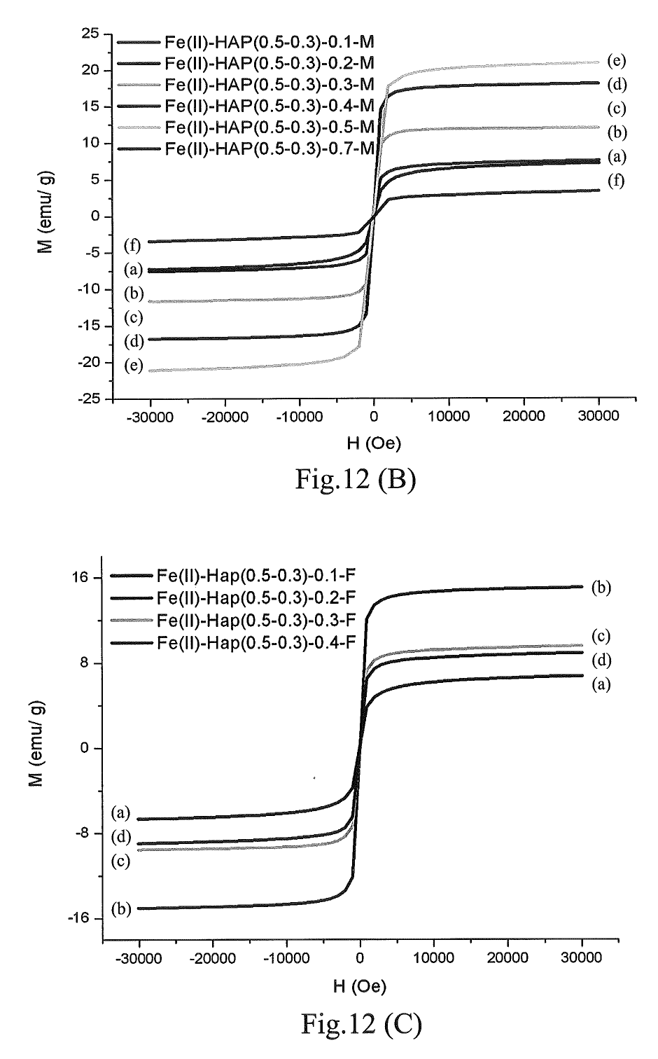

The observation by scanning electron microscopy shows that the crystal of m-HAP has spherical shape (20 to 50 nm) and is hardly affected by Fe content (See FIG. 6). Analysis by atomic force microscope shows the same result (See FIG. 7). Analysis by high resolution transmission electron microscopy conforms that m-HAP maintain the crystalline structure of HAP without any change (See FIG. 8). The measurement by superconducting quantum interference device shows that m-HAP has paramagnetic property and its magnetic force is increased with elevation of the Fe content (See FIG. 9). Analysis on lactic acid dehydrogenase after 3T3 cells have been incubated in the medium containing m-HAP for 4 and 24 hours respectively, shows that m-HAP has good biocompatibility and does not produce cytotoxicity.

The above preferred embodiments merely illustrate the present invention but do not intend to limit the present invention thereto. The persons skilled in the art may make some modifications or alterations on the present invention without departing its spirit and scope, and these modifications and alterations are included in the present invention. The scope of the present invention is defined by the appended claims.

We claim:

1. A method for preparing a biomedical material, comprising the following steps:
(1) preparing a suspension containing Ca ions and keeping said suspension at a specified temperature;
(2) adding dropwise a solution containing phosphate component at a constant rate to the suspension containing Ca ions in a specified Ca/P molar ratio can be obtained, then adjusting the resulting mixture with an alkaline solution to a weak alkaline pH;
(3) thoroughly stirring the mixture obtained from the step (2), then allowing it to stand until solubility balance is achieved;
(4) adding dropwise a solution containing a divalent or trivalent metal ion at a constant rate to the reaction mixture obtained from the step (3) in a specified metal ion/Ca molar ratio, then adjusting the resulting mixture with an alkaline solution to a weak alkaline pH; and
(5) collecting the precipitate from the mixture obtained from the step (4), then washing and drying the precipitate.

2. The method according to claim 1, wherein the product obtained in the step (5) is a biomedical material composed of magnetic nanoparticles.

3. The method according to claim 2, wherein the composition, crystalline phase, crystal size and shape of the nanoparticle can be controlled by adjusting the stoichiometric ratio of Ca, P and other metal.

4. The method according to claims 1, 2 or 3, wherein a source of calcium ion is selected from a group of calcium hydroxide, calcium chloride or calcium nitrate.

5. The method according to claims 1, 2 or 3, wherein the metal ion is an iron ion, and the source of the iron ion is selected from ferrous dichloride, ferric trichloride, ferric nitrate or ferric phosphate.

6. The method according to claim 1, wherein the specified temperature in the step (1) is 70 to 120° C.

7. The method according to claim 1, wherein the phosphate component in the step (2) is selected from phosphoric acid, sodium phosphate or dibasic ammonium phosphate ((NH₄)₂HPO₄).

8. The method according to claim 1, wherein the specified Ca/P molar ratio in the step (2) is 0.5 to 2.

9. The method according to claim 1, wherein the specified metal ion/Ca molar ratio in the step (4) is 0 to 1.4.

10. The method according to claim 1, wherein the divalent or trivalent metal ion in the step (4) is selected from Fe⁺², Ni⁺², Co⁺², Al⁺³, La⁺³ or Fe⁺³.

11. The method according to claims 1, 2 or 3, wherein the mixture obtained in the step (4) has a pH of 6 to 10.

12. A magnetic nanoparticle produced by the method according to claim 1, characterized in that the magnetic nanoparticle is composed of hydroxyapatite wherein the calcium ion originally existing in hydroxyapatite is replaced with a divalent or trivalent metal ion during synthesis of the magnetic nanoparticle.

13. The magnetic nanoparticle according to claim 12, wherein the divalent or trivalent metal ion is selected from Fe⁺², Ni⁺², Co⁺², Al⁺³, La⁺³ or Fe⁺³.

14. The magnetic nanoparticle according to claim 12, wherein the divalent or trivalent metal ion is an iron ion, and the source of the iron ion is selected from ferrous dichloride, ferric trichloride, ferric nitrate or ferric phosphate.

15. The magnetic nanoparticle according to claim 12, wherein the calcium ions originally existing in hydroxyapatite are replaced with divalent or trivalent metal ions by a substitution reaction.

16. The magnetic nanoparticle according to claim 12, wherein the composition ratio, shape, crystal size and physical/chemical properties of the nanoparticle are unchanged before and after replacement of Ca ion with the divalent or trivalent metal ion.

17. The magnetic nanoparticle according to claim 12, wherein the molar ratio of the metal ion to Ca is 0 to 1.4.

18. The magnetic nanoparticle according to claim 12, which can be used as the component of contrast media, a thermal therapeutic agent of tumor, a reagent for cell isolation, a drug-releasing preparation and a gene carrier.
